(19) United States
(12) Patent Application Publication
(10) Pub. No.: US 2002/0172932 A1
(43) Pub. Date: Nov. 21, 2002

(54) Interactive animation teaching method and the system for the same

(76) Inventors: Sayling Wen, Taipei (TW); Zechary Chang, Taipei (TW); Ken Kung, Taipei (TW)

Correspondence Address: BIRCH STEWART KOLASCH & BIRCH, PO BOX 747, FALLS CHURCH, VA, 22040-0747, US

(21) Appl. No.: 09/859,447

(22) Filed: May 18, 2001

(51) Int. Cl. G09B 3/00; G09B 5/00; G09B 7/00

(52) U.S. Cl. 434/350; 434/362; 434/307 R

(57) ABSTRACT

An interactive animation teaching system, comprising an animation object database, a project database, a selection accepting module, and an animation providing module. The animation object database stores at least one animation object datum. The project database stores at least one project datum, including project related animation data. The project related animation data include configuration settings relevant for each animation object in the project datum. The selection accepting module receives the animation object items and project items selected by a user. The animation providing module provides a project animation to the user according to the user selected animation object items and project items after integrating the corresponding animation object data in the animation object database and the corresponding project data in the project database in accordance with the relevant configuration settings. The invention also discloses an interactive animation teaching method for the system.

### BACKGROUND OF THE INVENTION

1. Field of Invention

The invention relates to an interactive teaching method and system. In particular, the invention relates to an interactive teaching method that utilizes computer technologies to provide an animation object database so that the user can select animation objects, and the corresponding system.

2. Related Art

Along with the advance in computer and network technologies, using computers to teach has become a new learning method. For example, using the computer feature of large data storage capacity, a database server with lots of problems can be provided to learners. The problems can be further grouped according to the difficulty. The user can connect to the problem database server to practice via a network. Another type of teaching method is performed in a multimedia form to simultaneously provide graphs, texts and sound to users in order to increase the amount of joy in learning and the desire of the user to learn.

However, conventional teaching activities using the computers or network are limited to fixed data browsing and transmission. In comparison to conventional books and classroom teaching, however, the increase in fun and interactivity is limited. For example, repeated learning is one of the most effective learning methods. Nevertheless, if the user wants to learn a specific project with a conventional computer teaching system, he is most likely to have the same contents repeated. This redundancy in learning content will greatly reduce the user's desire to learn.

### SUMMARY OF THE INVENTION

In view of the foregoing, it is an object of the invention to provide an interactive teaching method and the corresponding system, which allows the user to select animation objects, and thereby increase the desire of the user to learn.

It is another object of the invention to provide an interactive teaching method and the corresponding system, which allows cross searching of a practice problem database and a knowledge database so as to increase the learning efficiency of the user.

To achieve the above objective, the disclosed system includes an animation object database, a project database, a selection accepting module, and an animation providing module. The animation object database stores at least one animation object datum. The project database stores at least one project datum, including project related animation data. The project related animation data include configuration settings relevant for each animation object in the project datum. The selection accepting module receives the animation object items and project items selected by a user. The animation providing module provides a project animation to the user according to the user selected animation object items and project items after integrating the corresponding animation object data in the animation object database and the corresponding project data in the project database in accordance with the relevant configuration settings.

The invention also provides an interactive animation teaching method. The method first receives the user selected animation object items and project items. The corresponding animation object data are read in from the animation object database according to the user selected animation object items. The corresponding project data are read in from the project database according to the user selected project items. The project data contain at least project related animation data, including the relevant configuration settings of each animation object in the animation data. Finally, the animation object data and the project data are integrated according to the relevant configuration settings to provide a project animation to the user.

According to the disclosed system and method, the user can select animation objects on his own. Therefore, the same animation project can be presented in different ways. As a consequence, the desire of the user to learn can be effectively increased.

### BRIEF DESCRIPTION OF THE DRAWINGS

The invention will become more fully understood from the detailed description given in the herein below illustrations only, and thus are not limitative of the invention, and wherein:

FIG. 1 is a schematic view of the interactive animation teaching system structure according to a preferred embodiment of the invention;

FIG. 2(A) is a schematic view of the data structure in the animation object database of the system in FIG. 1;

FIG. 2(B) is a schematic view of the data structure in the project database of the system in FIG. 1;

FIG. 2(C) is a schematic view of the data structure in the practice problem database of the system in FIG. 1;

FIG. 2(D) is a schematic view of the data structure in the knowledge database of the system in FIG. 1;

FIG. 2(E) is a schematic view of the data structure in the project/practice problem correspondence table of the system in FIG. 1;

FIG. 2(F) is a schematic view of the data structure in the project/knowledge data correspondence table of the system in FIG. 1;

FIG. 3 is a flowchart showing the procedure to implement the interactive animation teaching method according to a preferred embodiment of the invention; and

FIGS. 4(A) and 4(B) are schematic views showing the result of integrating animation object data and project data according to the relevant configuration settings according to the method in FIG. 3.

### DETAILED DESCRIPTION OF THE INVENTION

Preferred embodiments of the interactive animation teaching system and method of the invention will be apparent from the following detailed description, which proceeds with reference to the accompanying drawings, wherein the same references relate to the same elements.

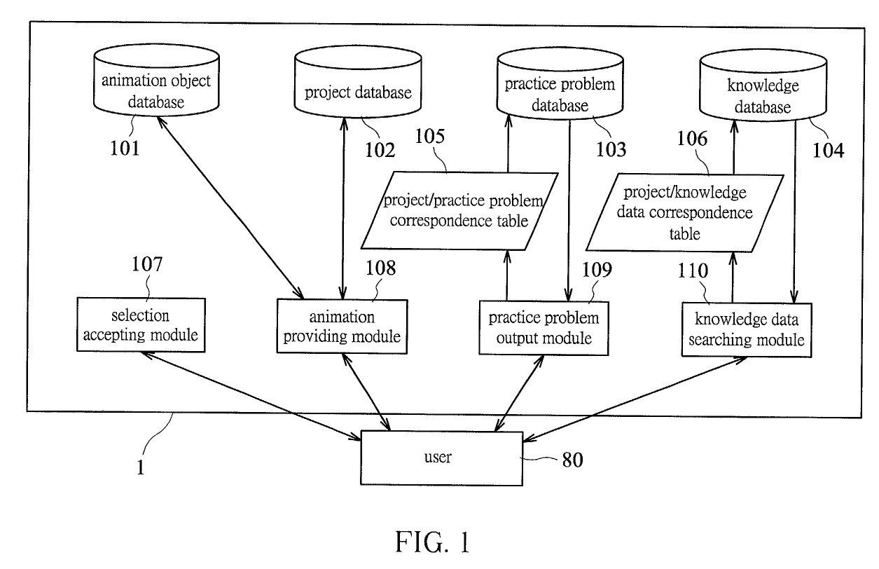

With reference to FIG. 1, a preferred embodiment of the interactive animation teaching system 1 has four databases, namely, an animation object database 101, a project database 102, a practice problem database 103, and a knowledge database 104. In the current embodiment, the four databases are stored on the same hard disk drive (HDD). However, they can also be stored on an optical disk or a floppy disk, or separately stored on different HDDs according to practical needs.

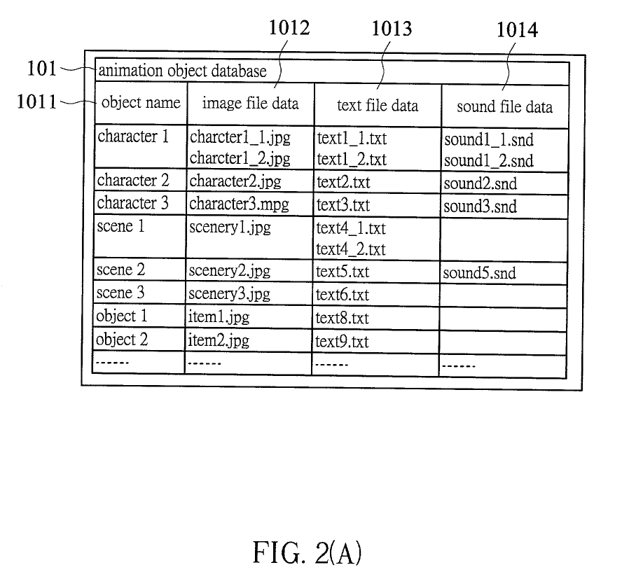

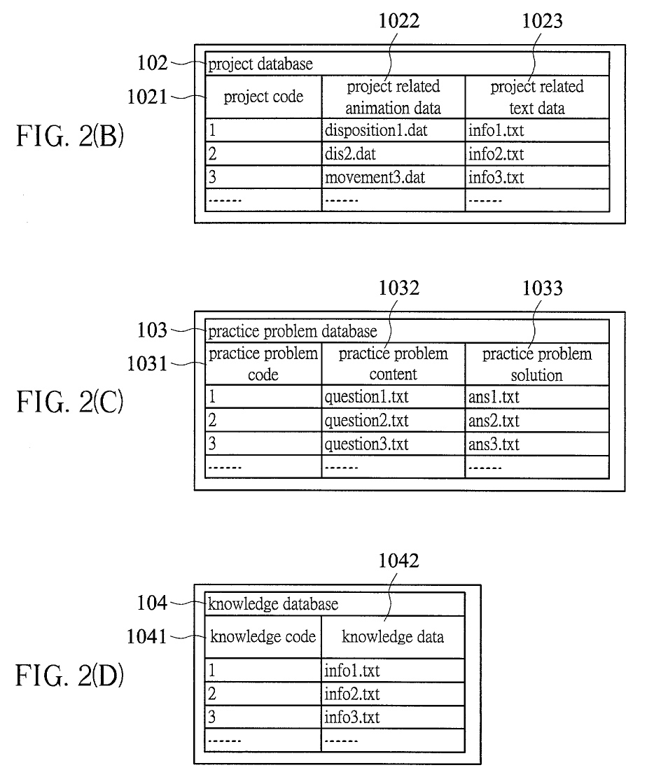

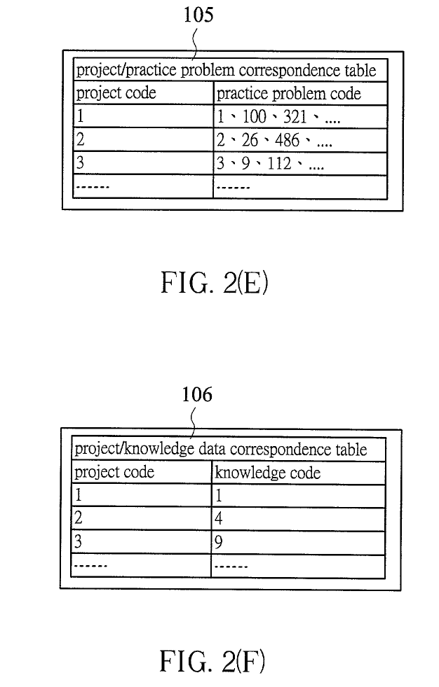

The animation object database 101 stores at least one animation object datum. With reference to FIG. 2(A), the animation object data in this embodiment include object names 1011, image file data 1012, text file data, and sound file data 1014. Taking the first animation object in the animation object database 101 as an example, the object name 1011 is character 1. The image file data 1012 include two image files “character1-1.jpg” and “character1-2.jpg”. This means that this character may appear in two different gestures (such as sitting and standing). The text file data 1013 includes a text file “text1.txt” storing the words this character would say. The sound file data 1014 has a sound file “sound1.snd” storing the voice corresponding to the words said by this character.

With reference to FIG. 2(B), the project database 102 stores project codes 1021 of each animation project, project related animation data 1022 and project related text data 1023. The so-called project related animation data 1022 refer to each object in the project animation, such as configuration settings of scenes, characters, and objects. For example, the configuration settings are the relative positions, or changing orders of scenes or characters. The project related text data 1023 refer to the contents of the text displayed while the animation is playing. This part will be further explained in a later section of the specification.

Referring to FIG. 2(C), the practice problem database 103 stores practice problem codes 1031 for each practice problem, practice problem contents 1032, and practice problem solutions 1033. In the current embodiment, the practice problem contents 1032 and practice problem solutions 1033 are stored in the text file format. However, they can also be stored in other formats, such as graphs, sound or HTML documents without departing from the spirit of the invention.

Referring to FIG. 2(D), the knowledge database 104 stores knowledge codes 1041 and knowledge data 1042. In the current embodiment, the knowledge data 1042 are stored in the text file format. They can also be stored in other formats, such as graphs, sound or HTML documents without departing from the spirit of the invention.

The interactive animation teaching system 1 has, in addition, two tables, namely, a project/practice problem correspondence table 105 and a project/knowledge data correspondence table 106. With reference to both FIGS. 2(E) and 2(F), the project/practice problem correspondence table 105 stores the correspondent relations between each animation project and practice problem. The project/knowledge data correspondence table 106 stores the correspondent relations between the animation projects and the knowledge data. The animation projects and knowledge data have a one-to-one correspondence.

When a user 80 uses the interactive animation teaching system 1, the selection accepting module 107 first receives the animation object items and project items selected by the user 80. The animation providing module 108 thereby integrates the corresponding animation object data in the animation object database 101 and the corresponding project data in the project database 102 to provide a project animation to the user 80. Subsequently, a practice problem output module 109 outputs the practice problem data that correspond to the project data from the practice problem database 103 to the user 80 according to the project/practice problem correspondence table 105. A knowledge data searching module 110 accepts the search request from a user and looks up the corresponding knowledge data from the knowledge database 104 for the user 80 according to the project/knowledge data correspondence table 106. In the following paragraphs, please refer to the relevant drawings for a detailed description of the above-mentioned procedure.

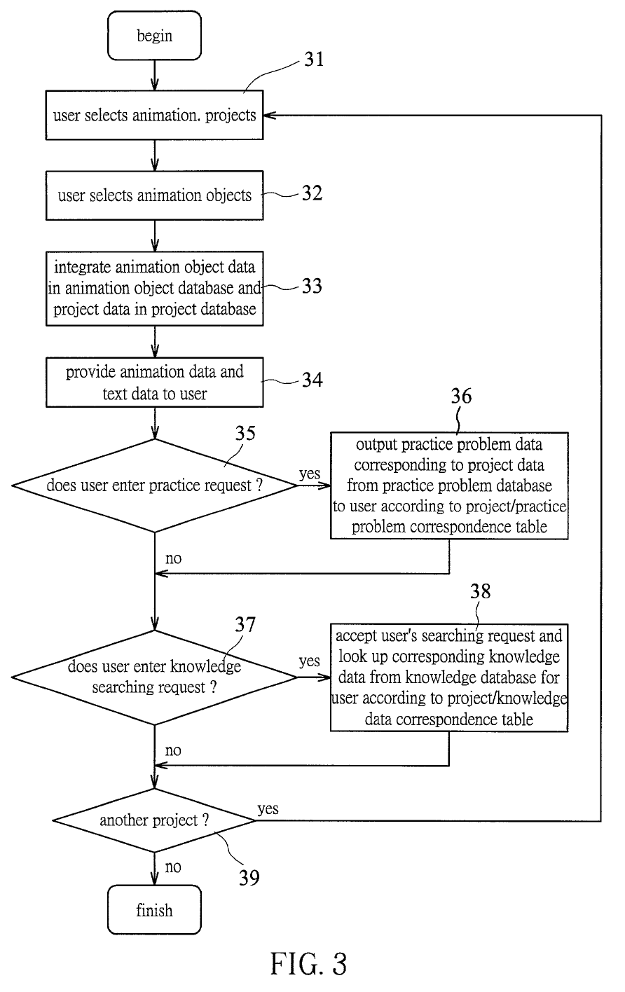

With reference to FIG. 3, the selection accepting module 107 receives animation projects selected by the user 80 in step 31. Taking English teaching as an example, the user 80 can select such projects as vocabulary or grammar. Each project has different project related animation data and project related text data.

In step 32, the selection accepting module 107 receives animation objects selected by the user 80. Since the project related animation data in each project only define the configuration settings of the scenes, characters and objects in the project animation but not the contents thereof, the animation providing module 108 is able to provide a complete animation project to the user 80 after accepting the animation objects selected by the user 80.

After the user 80 selects projects and animation objects, the animation providing module 108 starts to integrate animation object data in the animation object database and the project data in the project database 102 in step 33. For example, when the animation object is a character, the animation providing module 108 can retrieve the corresponding image file data from the animation object database 101. In accordance with the project related animation data settings, the position of the image file data is moved to produce animation effects.

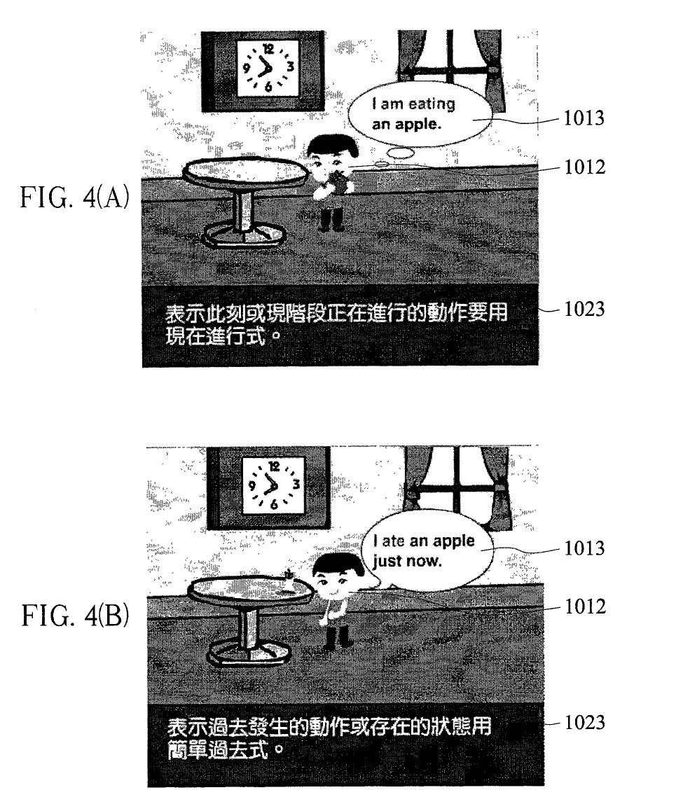

Please refer to FIGS. 4(A) and 4(B) for a further description on how the animation providing module 108 integrates the animation object data in the animation object database 101 and the project data in the project database 102.

FIGS. 4(A) and 4(B) show the project animation contents with a project code “1” in the project database 102. The scene shown in FIGS. 4(A) and 4(B) employs the animation object “character 1” in the animation object database 101, which includes two image files data 1012 and two text file data 1013. In FIG. 4(A), the image file data 1012 and text file data 1013 are “character1_{—}1.jpg” and “text1_{—}1.txt”, respectively. In FIG. 4(B), the image file data 1012 and text file data 1013 are “character1_{—}2.jpg” and “text1_{—}2.txt”, respectively.

The positions of scene and/or character images and texts in FIGS. 4(A) and 4(B) are configured according to the settings recorded in the project animation related data 1022, i.e., the file “disposition1.dat”. The texts at the bottom of FIGS. 4(A) and 4(B) are the project related text data 1023, i.e., the contents in the file “infor1.txt”.

The animation providing module 108 integrates to form the project animation with the project code “1” as shown in FIG. 4(A) and 4(B) according to the settings in the file “disposition1.dat”. Once the integration is complete, the animation providing module 108 provides a complete project animation including animation, texts, and sound to the user 80 in step 34 in FIG. 3. The project animation can be an HTML file that is sent to the user via the Internet.

In step 35, if the user 80 enters a practice request, step 36 is performed. A practice problem output module 109 outputs the corresponding practice problem data from the practice problem database 103 to the user 80 according to the project/practice problem correspondence table 105. If the user 80 enters a knowledge search request in step 37, step 38 then follows so that a knowledge data searching module 110 can output knowledge data to the user 80 from the knowledge database 104 according to the project/knowledge data correspondence table 106.

Finally, if the user 80 wants to continue on to another project in step 39, the procedure returns to step 31. Otherwise, the whole procedure finishes.

Through the above procedure, the user 80 can freely set the animation contents he likes so that the same animation project can be presented in different fashions.

Certain variations would be apparent to those skilled in the art, which variations are considered within the spirit and scope of the claimed invention.

What is claimed is:

1. An interactive animation teaching system, which comprises:
an animation object database, which stores at least one animation object datum;
a project database, which stores at least one project datum that contains a project related animation data recording relevant to the configuration settings of each animation object in the project datum;
a selection accepting module, which receives an animation object item and a project item selected by a user; and
an animation providing module, which provides a project animation to the user according to the user selected animation object item and project item after integrating the corresponding animation object data in the animation object database and the corresponding project data in the project database in accordance with the relevant configuration settings.

2. The system of claim 1, wherein the animation object data contain image file data.

3. The system of claim 1, wherein the animation object data contain text file data.

4. The system of claim 1, wherein the animation object data contain sound file data.

5. The system of claim 1, wherein the project data contain at least one project related animation datum and at least one project related text datum.

6. The system of claim 1 further comprising:
a practice problem database, which stores at least one practice problem datum;
a project/practice problem correspondence table, which stores the correspondent relations between the project data and the practice problem data; and
a practice problem output module, which outputs the practice problem data corresponding to the project data from the practice problem database to the user in accordance with the project/practice problem correspondence table.

7. The system of claim 1 further comprising:
a knowledge database, which stores at least one knowledge datum;
a project/knowledge data correspondence table, which stores the correspondent relations between the project data and the knowledge data; and
a knowledge data searching module, which receives the search request from the user and looks up and outputs the knowledge data corresponding to the search request from the knowledge database to the user in accordance with the project/knowledge data correspondence table.

8. The system of claim 1, wherein the selection accepting module receives the animation object item and the project item selected by the user via a network.

9. The system of claim 1, wherein the animation providing module provides the project animation to the user via a network.

10. An interactive animation teaching method, which comprises the steps of:
accepting an animation object item and a project item selected by a user;
reading in the animation object data corresponding to the user selected animation object item from an animation object database;
reading in the project data corresponding to the user selected project item from a project database, wherein the project data contain at least project related animation data that include configuration settings for each animation object in the project data; and
providing a project animation to the user according to the relevant configuration settings by integrating the animation object data and the project data.

11. The method of claim 10, wherein the animation object data contain image file data.

12. The method of claim 10, wherein the animation object data contain text file data.

13. The method of claim 10, wherein the animation object data contain sound file data.

14. The method of claim 10, wherein the project datum contains at least one project related animation datum and at least one project related text datum.

15. The method of claim 10 further comprising the steps of:
outputting to the user at least one practice problem data from a practice problem database corresponding to the project data in accordance with a project/practice problem correspondence table, wherein the practice problem database stores at least one practice problem datum and the project/practice problem correspondence table stores the correspondent relations between the project data and the practice problem data.

16. The method of claim 10 further comprising the steps of:
receiving the search request from a user and looking up and outputting to the user the knowledge data corresponding to the search request from the knowledge database in accordance with a project/knowledge data correspondence table; wherein the knowledge database stores at least one knowledge datum and the project/knowledge data correspondence table stores the correspondent relations between the project data and the knowledge data.

17. The method of claim 10, wherein the selection accepting module receives the animation object item and the project item selected by the user via a network.

18. The method of claim 10, wherein the animation providing module provides the project animation to the user via a network.

19. A recording medium recording the data for implementing the method of claim 10, which stores:
an animation object database, which stores at least one animation object datum;
a project database, which stores at least one project datum that contains project related animation data recording the relevant configuration settings of each animation object in the project datum;
a selection accepting module, which receives an animation object item and a project item selected by a user; and
an animation providing module, which provides a project animation to the user according to the user selected animation object item and project item after integrating the corresponding animation object data in the animation object database and the corresponding project data in the project database in accordance with the relevant configuration settings.

20. The recording medium of claim 19 which further stores:
a practice problem database, which stores at least one practice problem datum;
a project/practice problem correspondence table, which stores the correspondent relations between the project data and the practice problem data; and
a practice problem output module, which outputs the practice problem data corresponding to the project data from the practice problem database to the user in accordance with the project/practice problem correspondence table.

21. The recording medium of claim 19 which further stores:
a knowledge database, which stores at least one knowledge datum;
a project/knowledge data correspondence table, which stores the correspondent relations between the project data and the knowledge data; and
a knowledge data searching module, which receives the search request the user and looks up and outputs the knowledge data corresponding to the search request from the knowledge database to the user in accordance with the project/knowledge data correspondence table.
